(19) United States
(12) Patent Application Publication
(10) Pub. No.: US 2015/0224380 A1
(43) Pub. Date: Aug. 13, 2015

(54) Measurement System and Measurement Device

(71) Applicant: Mizuno Corporation, Osaka (JP)

(72) Inventors: Mototaka Iwata, Osaka (JP); Takeshi Naruo, Osaka (JP); Yuichi Shimizu, Osaka (JP); Shohei Shibata, Osaka (JP); Makoto Uchishima, Kanagawa (JP)

(21) Appl. No.: 14/616,937

(22) Filed: Feb. 9, 2015

(30) Foreign Application Priority Data
Feb. 13, 2014 (JP) 2014025389

(51) Int. Cl. A63B 69/00; G01P 3/02; G01P 15/00

(52) U.S. Cl. CPC A63B 69/0002; G01P 15/00; G01P 3/02; A63B 2069/0008

(57) ABSTRACT

A measurement system capable of easily notifying a subject of characteristics of motion during swing is provided. A measurement system for measuring motion of a subject includes a detection unit attached to a lower back portion of the subject, which is capable of obtaining motion information on motion of the lower back portion during swing by the subject, a processing unit finding an evaluation parameter for a swing by the subject based on the motion information obtained by the detection unit, and an output unit outputting the evaluation parameter found by the processing unit.

This nonprovisional application is based on Japanese Patent Application No. 2014-25389 filed with the Japan Patent Office on Feb. 13, 2014, the entire contents of which are hereby incorporated by reference.

### BACKGROUND OF THE INVENTION

1. Field of the Invention

The present disclosure relates to a technique for measuring motion during swing by a subject.

2. Description of the Background Art

In sports played with a ball hitting instrument such as a baseball bat or a tennis racket, capability to swing a ball hitting instrument is an important indicator for playing a game from a position of strength. Therefore, various methods for evaluating a swing with a ball hitting instrument have conventionally been proposed.

For example, Japanese Patent Laying-Open No. 2001-129145 discloses an exercise machine for sporting equipment. This exercise machine includes an acceleration sensor contained in a bat and a control unit for operating an acceleration and performing display processing of a result of operation.

Japanese Patent Laying-Open No. 2009-125499 discloses a tennis swing improvement support system. This system includes a detection unit provided in a racket for detecting at least one of a track of the racket or change in orientation of a racket face during swing and a notification unit for providing information for improvement in swing based on a result of detection by the detection unit.

According to Japanese Patent Laying-Open No. 2001-129145, in connection with such an instrument as a baseball bat, a numeric value for a maximal head speed, quality of a swing, and timing thereof can be recognized in real time. According to Japanese Patent Laying-Open No. 2009-125499, a user is notified of information for improvement in swing at the time when he/she swung a racket (a position of hitting of a ball), so that improvement in swing can be supported.

Neither of Japanese Patent Laying-Open No. 2001-129145 and Japanese Patent Laying-Open No. 2009-125499, however, gives an indicator for motion of a subject during swing. In addition, a dedicated ball hitting instrument is required and a swing with the use of a bat (or a racket) to which a subject is used cannot be evaluated.

### SUMMARY OF THE INVENTION

The present disclosure was made to solve the problems as above, and an object thereof is to provide a measurement system and a measurement device capable of easily notifying a subject of characteristics of motion during swing.

According to one embodiment, a measurement system for measuring motion of a subject is provided. The measurement system includes a detection unit attached to a lower back portion of the subject and configured to obtain motion information on motion of the lower back portion during swing by the subject, a processing unit configured to find an evaluation parameter for a swing by the subject based on the motion information obtained by the detection unit, and an output unit configured to output the evaluation parameter found by the processing unit.

Preferably, the motion information includes an angular speed around a body axis of the subject and an acceleration in a direction of swing at the lower back portion of the subject. The processing unit calculates as the evaluation parameter, a time difference between a time at which an absolute value of the angular speed around the body axis is maximal and a time at which the acceleration in the direction of swing is zero.

According to another embodiment, a measurement system for measuring motion of a subject is provided. The measurement system includes a first detection unit attached to a lower back portion of the subject and configured to obtain first motion information on motion of the lower back portion during swing by the subject, a second detection unit attached to a back of a hand of the subject and configured to obtain second motion information on motion of the back of the hand during swing by the subject, a processing unit configured to find at least one evaluation parameter for a swing by the subject based on the first motion information obtained by the first detection unit and the second motion information obtained by the second detection unit, and an output unit configured to output at least one evaluation parameter found by the processing unit.

Preferably, the first motion information includes an angular speed around a body axis of the subject. The second motion information includes an angular speed around an axis orthogonal to the back of the hand of the subject. The processing unit finds a time difference between a time at which an absolute value of the angular speed around the body axis of the subject is maximal and a time at which an absolute value of the angular speed around the axis orthogonal to the back of the hand of the subject is maximal immediately before impact.

Preferably, the second motion information further includes an acceleration in a direction of swing at the back of the hand of the subject. The processing unit finds a time difference between a time at which an absolute value of an angular speed around a body axis of the subject is maximal and a time at which a rate of change in acceleration in the direction of swing at the back of the hand of the subject is zero.

Preferably, the second motion information further includes respective angular speeds around three axes at the back of the hand of the subject. The processing unit finds a swing speed at the time of impact based on a square-root of sum of squares of the angular speeds around the three axes at the time of impact and a total length of a bat used by the subject.

Preferably, the second motion information further includes an acceleration in a direction of swing at the back of the hand of the subject. The processing unit calculates a swing time period of the subject by finding a time difference between a time at which a rate of change in acceleration in the direction of swing at the back of the hand of the subject is not smaller than a predetermined threshold value and an impact time.

Preferably, the processing unit evaluates a swing level of the subject based on the evaluation parameter obtained from the subject and a predetermined rule. The output unit outputs the swing level together with the evaluation parameter.

According to yet another embodiment, a measurement device attached to a lower back portion of a subject for measuring motion of the subject is provided. The measurement device includes a first detection unit configured to obtain first motion information on motion of the lower back portion during swing by the subject, an input unit configured to accept input of second motion information on motion of a back of a hand during swing by the subject, which is obtained by a second detection unit attached to the back of the hand of the subject, a processing unit configured to find at least one evaluation parameter for a swing by the subject based on the first motion information obtained by the first detection unit and the second motion information of which input has been accepted by the input unit, and an output unit configured to output at least one evaluation parameter found by the processing unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an overall configuration of a measurement system according to a first embodiment.

FIGS. 2A and 2B are diagrams for illustrating a relative coordinate system set on a back of a right hand of a batter.

FIG. 3 is a flowchart for illustrating overview of an operation of the measurement system according to the first embodiment.

FIG. 4 is a block diagram showing a hardware configuration of a terminal device according to the first embodiment.

FIG. 5 is a block diagram showing a hardware configuration of a sensor device according to the first embodiment.

FIG. 6 is a diagram (No. 1) for illustrating a scheme for calculating an evaluation parameter calculated from motion information.

FIG. 7 is a diagram showing a result of calculation of an evaluation parameter A for each of a plurality of intermediate-level persons and advanced-level persons.

FIG. 8 is a diagram (No. 2) for illustrating a scheme for calculating an evaluation parameter calculated from motion information.

FIG. 9 is a diagram showing correlation between evaluation parameters of a plurality of baseball club members and sensory evaluation by a skilled instructor of a swing by those intermediate-level persons.

FIG. 10 is a diagram exemplifying relation between an evaluation parameter B and a swing level.

FIG. 11 is a diagram (No. 3) for illustrating a scheme for calculating an evaluation parameter calculated from motion information.

FIG. 12 is a diagram showing correlation between evaluation parameters C of a plurality of baseball club members and sensory evaluation by a skilled instructor of a swing by each baseball club member.

FIG. 13 is a diagram exemplifying relation between evaluation parameter C and a swing level.

FIG. 14 is a flowchart showing a procedure of processing in the sensor device according to the first embodiment.

FIG. 15 is a flowchart showing a procedure of processing in the terminal device according to the first embodiment.

FIG. 16 is a diagram showing an overall configuration of a measurement system according to a second embodiment.

FIG. 17 is a diagram showing a hardware configuration of a terminal device according to the second embodiment.

FIG. 18 is a flowchart showing a procedure of processing in the terminal device according to the second embodiment.

FIG. 19 is a diagram (No. 4) for illustrating a scheme for calculating an evaluation parameter calculated from motion information.

FIG. 20 is a diagram (No. 5) for illustrating a scheme for calculating an evaluation parameter calculated from motion information.

FIG. 21 is a diagram (No. 6) for illustrating a scheme for calculating an evaluation parameter calculated from motion information.

FIG. 22 is a diagram (No. 7) for illustrating a scheme for calculating an evaluation parameter calculated from motion information.

FIG. 23 is a diagram (No. 8) for illustrating a scheme for calculating an evaluation parameter calculated from motion information.

### DESCRIPTION OF THE PREFERRED EMBODIMENTS

The present embodiment will be described below. The same or corresponding elements have the same reference characters allotted and description thereof may not be repeated.

When the number, a quantity or the like is mentioned in the embodiment described below, the scope of the present invention is not necessarily limited to the number, the quantity or the like, unless otherwise specified. Each constituent element in the embodiment below is not necessarily essential in the present invention, unless otherwise specified.

### First Embodiment

<Overall Configuration of System>

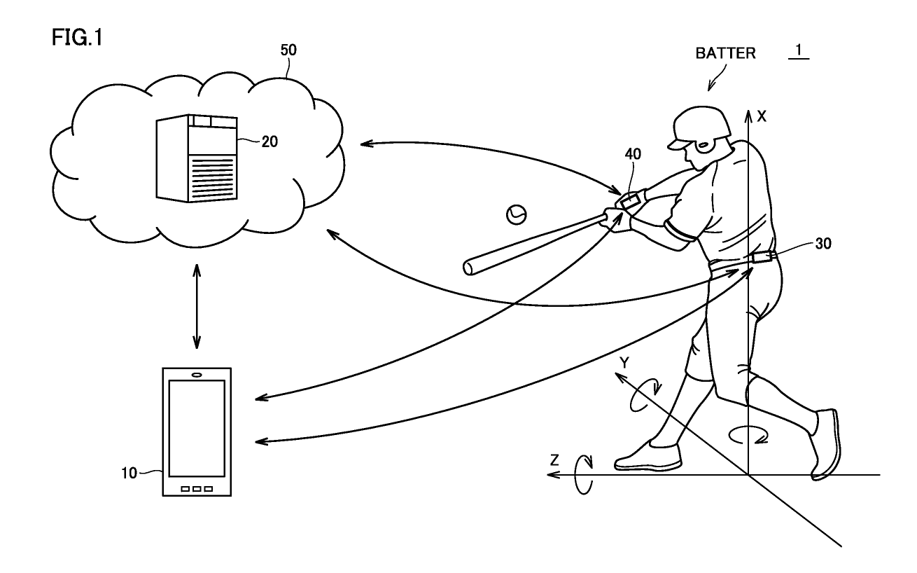

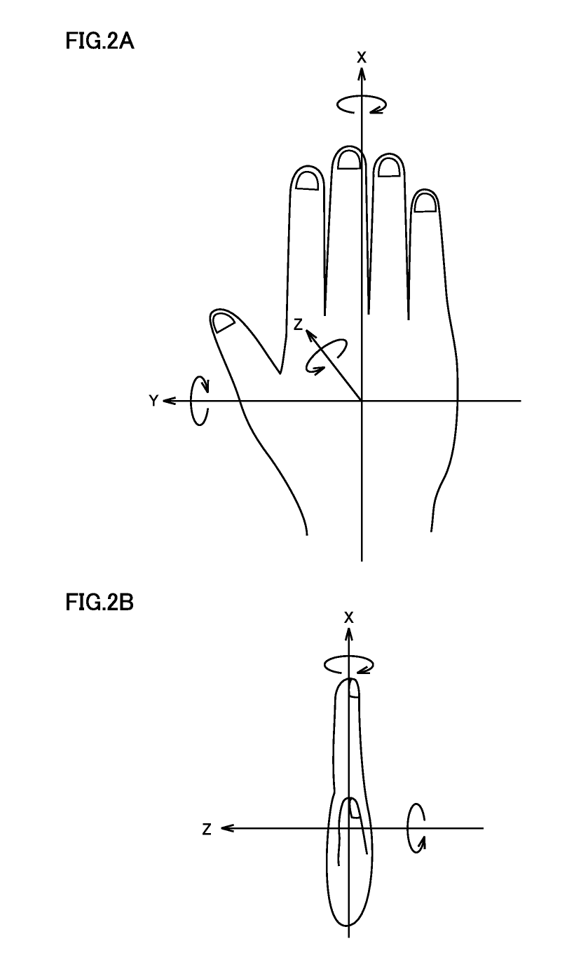

An overall configuration of a measurement system according to a first embodiment will be described with reference to FIGS. 1 and 2A and 2B. FIG. 1 is a diagram showing an overall configuration of a measurement system 1 according to the first embodiment. FIGS. 2A and 2B are diagrams for illustrating a relative coordinate system set on a back of a right hand of a batter. Specifically, FIG. 2A is a diagram showing a relative coordinate system when viewed from the back of the right hand of the batter. FIG. 2B is a diagram showing the relative coordinate system when viewed from a side surface of the back of the right hand of the batter. A “back of a hand” herein means a dorsal portion of a hand from a wrist including a radius and an ulna to the base of five fingers.

Referring to FIG. 1, measurement system 1 for measuring motion of a subject includes a terminal device 10, a server 20, a sensor device 30 attached to a lower back portion of the subject (a batter), and a sensor device 40 attached to a back of a hand of the batter. In the first embodiment, the subject is assumed as a left-handed batter.

In the first embodiment, a case that terminal device 10 is implemented by a smartphone will be described. Terminal device 10, however, can be implemented by any device regardless of a type. For example, terminal device 10 may be a tablet terminal, a personal digital assistant (PDA), a notebook personal computer (PC), or a desktop PC.

Terminal device 10 is configured to be able to establish wireless communication with server 20 and sensor devices 30 and 40. For example, terminal device 10 communicates with server 20 as terminal device 10 is connected to a network 50 such as the Internet. Terminal device 10 communicates with sensor devices 30 and 40 by making use of Bluetooth®, wireless local area network (LAN), or infrared communication. Terminal device 10 may be configured to be able to establish wired communication making use of a universal serial bus (USB).

Server 20 can communicate with terminal device 10 and sensor devices 30 and 40 as it is connected to network 50 such as the Internet, receives information on motion of a batter transmitted from each of sensor device 30 and sensor device 40, performs prescribed processing based on the motion information, and transmits a result of processing to terminal device 10.

Sensor device 30 includes an angular speed sensor capable of measuring an angular speed around three axes (an X axis, a Y axis, and a Z axis in FIG. 1) orthogonal to one another and an acceleration sensor capable of measuring an acceleration in directions of the three axes (the X axis, the Y axis, and the Z axis in FIG. 1) orthogonal to one another. Sensor device 40 includes an angular speed sensor capable of measuring an angular speed around (an X axis, a Y axis, and a Z axis in FIGS. 2A and 2B) and an acceleration sensor capable of measuring an acceleration in directions of three axes (the X axis, the Y axis, and the Z axis in FIGS. 2A and 2B) orthogonal to one another. For example, sensor devices 30 and 40 have a time resolution of 0.001 second.

Referring to FIG. 1, sensor device 30 is attached to a lower back portion of a batter with a lower-back-portion attachment member (not shown) being interposed, such that one of the three axes in the angular speed sensor and the acceleration sensor is oriented in a direction of a body axis of the batter (the X axis in FIG. 1: an axis extending from the lower back portion toward a head portion). The Y axis is set to an axis extending in a direction of swing of the batter, and the Z axis is set to an axis extending in a direction perpendicular to the X axis and the Y axis. Here, the direction of swing is a direction in which a ball is hit (a direction of a batted ball).

The lower-back-portion attachment member is constructed such that sensor device 30 can be fixed to the lower back portion of the batter along a prescribed direction. Thus, sensor device 30 can measure an angular speed around the three axes (the X axis, the Y axis, and the Z axis in FIG. 1) described above and an acceleration in the directions of the three axes (the X axis, the Y axis, and the Z axis in FIG. 1). Namely, sensor device 30 is attached to the lower back portion of the batter and configured to be able to obtain motion information on motion of the lower back portion during swing by the batter. Specifically, this motion information refers to respective angular speeds around the three axes at the lower back portion and an acceleration in the directions of the three axes.

Referring to FIGS. 2A and 2B, sensor device 40 is attached to a back of a hand of the batter, with a back-of-hand attachment member (not shown) being interposed, such that one of the three axes in the angular speed sensor and the acceleration sensor is oriented along an axis extending from the center of a palm of the batter toward a long finger (the X axis in FIGS. 2A and 2B). The Y axis is set to an axis orthogonal to the X axis and extending in a direction of width of the palm of the batter, and the Z axis is set to an axis extending in a direction orthogonal to the back of the hand (an axis extending from the palm to the back of the hand).

The back-of-hand attachment member is constructed such that sensor device 40 can be fixed to the back of the hand of the batter along a prescribed direction. Thus, sensor device 40 can measure angular speeds around the three axes (the X axis, the Y axis, and the Z axis in FIGS. 2A and 2B) described above and an acceleration in directions of the three axes (the X axis, the Y axis, and the Z axis in FIGS. 2A and 2B). Namely, sensor device 40 is attached to the back of the hand of the batter and configured to be able to obtain motion information on motion of the back of the hand during swing by the batter. Specifically, this motion information refers to respective angular speeds around the three axes at the back of the hand and an acceleration in directions of the three axes.

In a case of a right-handed batter, measurement may be conducted with sensor device 40 being attached to any of the back of the right hand and the back of the left hand, and in a case of a left-handed batter as well, measurement may be conducted with sensor device 40 being attached to any of the back of the right hand and the back of the left hand.

<Overview of Operation of System>

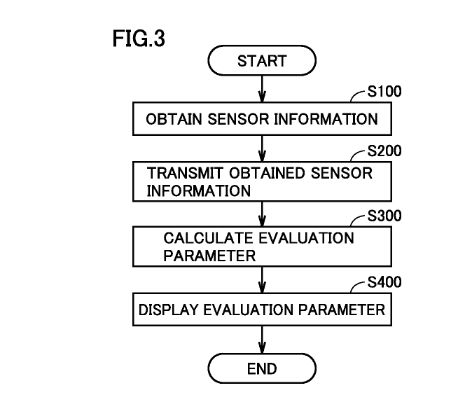

FIG. 3 is a flowchart for illustrating overview of an operation of measurement system 1 according to the first embodiment.

Referring to FIG. 3, in measurement system 1 according to the first embodiment, initially, when a batter swings a bat at a ball, sensor device 30 attached to the lower back portion of the batter and sensor device 40 attached to the back of a hand of the batter each obtain motion information (data on an acceleration and an angular speed at each attachment position) (step S100). The bat may be any bat such as a bat prepared by the batter himself/herself or a bat prepared by others. The batter may swing at a ball arranged on a tee or swing at a thrown ball.

Then, each of sensor devices 30 and 40 transmits obtained motion information to terminal device 10 (or server 20) (step S200). For example, each of sensor devices 30 and 40 transmits motion information to server 20 when motion information has an amount not smaller than a prescribed reference amount of data, and transmits motion information to terminal device 10 when the motion information has an amount smaller than the prescribed reference amount of data.

Then, terminal device 10 receives the motion information transmitted from each of sensor devices 30 and 40 and calculates an evaluation parameter for evaluating a swing by the batter, based on the motion information (step S300). Specifically, terminal device 10 receives the motion information obtained by sensor device 30 and the motion information obtained by sensor device 40, and calculates at least one evaluation parameter associated with the swing by the batter, based on such motion information.

When each of sensor devices 30 and 40 transmits motion information to server 20, server 20 calculates an evaluation parameter for evaluating a swing by the batter based on the motion information. Specifically, server 20 calculates at least one evaluation parameter associated with the swing by the batter based on the motion information obtained by sensor device 30 and the motion information obtained by sensor device 40. Then, server 20 transmits the calculated evaluation parameter to terminal device 10.

Then, terminal device 10 outputs calculated at least one evaluation parameter (step S400). Specifically, terminal device 10 displays the evaluation parameter on a display. Terminal device 10 may evaluate a swing level of the batter based on the evaluation parameter and a predetermined rule, and display the swing level on the display together with the evaluation parameter. For example, the predetermined rule refers to a swing evaluation level created in accordance with a value for an evaluation parameter, for each evaluation parameter.

<Hardware Configuration>

(Terminal Device 10)

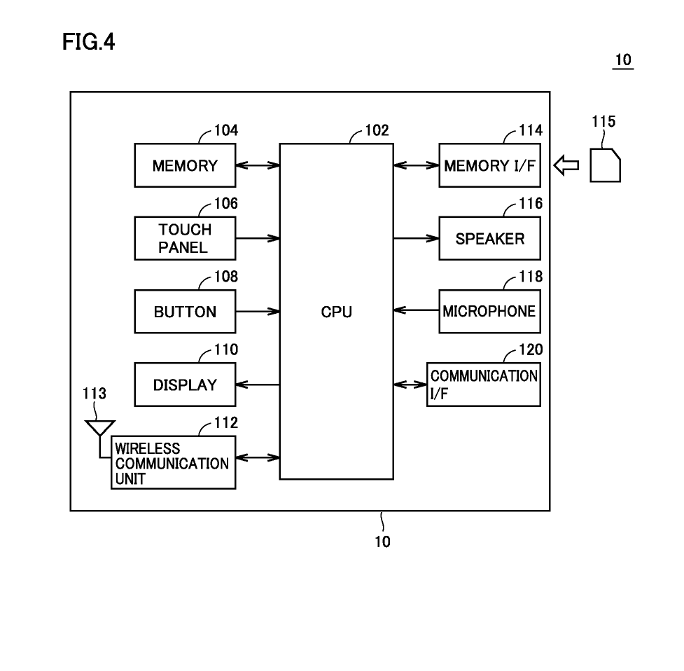

FIG. 4 is a block diagram showing a hardware configuration of terminal device 10 according to the first embodiment. Referring to FIG. 4, terminal device 10 includes as main constituent elements, a central processing unit (CPU) 102, a memory 104, a touch panel 106, a button 108, a display 110, a wireless communication unit 112, a communication antenna 113, a memory interface (I/F) 114, a speaker 116, a microphone 118, and a communication interface (I/F) 120. A storage medium 115 is an external storage medium.

CPU 102 controls an operation of each unit of terminal device 10 by reading and executing a program stored in memory 104. More specifically, CPU 102 implements each of processes (steps) in terminal device 10 which will be described later, by executing the program.

Memory 104 is implemented by a random access memory (RAM), a read-only memory (ROM), or a flash memory. Memory 104 stores a program executed by CPU 102 or data used by CPU 102 and the like.

Touch panel 106 is provided on display 110 having a function as a display unit, and may be any type of a resistive film type and a capacitance type and the like.

Button 108 is arranged on a surface of terminal device 10, accepts an instruction from a user, and inputs the instruction to CPU 102.

Wireless communication unit 112 establishes connection with a mobile communication network through communication antenna 113 and transmits and receives a signal for wireless communication. Thus, terminal device 10 can communicate with a prescribed communication device (such as server 20) through a mobile communication network such as a third-generation mobile communication system (3G) or long term evolution (LTE).

Memory interface (I/F) 114 reads data from external storage medium 115. Namely, CPU 102 reads data stored in external storage medium 115 through memory interface 114 and has the data stored in memory 104. CPU 102 reads data from memory 104 and has the data stored in external storage medium 115 through memory interface 114.

Storage medium 115 is exemplified by a medium storing a program in a non-volatile manner such as a compact disc (CD), a digital versatile disk (DVD), a Blu-ray™ disc (BD), a universal serial bus (USB) memory, a memory card, a flexible disk (FD), or a hard disk.

Speaker 116 outputs audio sound based on a command from CPU 102. Microphone 118 accepts utterance to terminal device 10.

Communication interface (I/F) 120 is, for example, a communication interface for transmitting and receiving data to and from sensor devices 30 and 40, and implemented by an adapter or a connector. A communication scheme is exemplified by wireless communication based on Bluetooth or wireless LAN and the like, or wired communication making use of a USB.

(Server 20)

Server 20 should only be able to generally provide information processing as will be described later, and a known hardware configuration can be adopted therefor. Therefore, detailed description of the hardware configuration of server 20 is not provided. For example, server 20 includes a CPU for performing various types of processing, a memory for storing data and a program executed by the CPU, and a communication interface for communication with terminal device 10 and sensor devices 30 and 40.

(Sensor Devices 30 and 40)

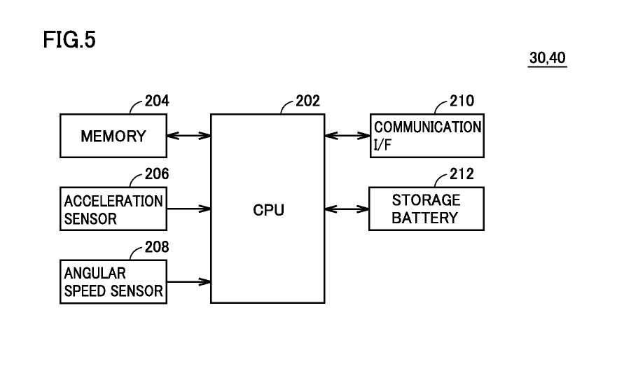

FIG. 5 is a block diagram showing a hardware configuration of sensor devices 30 and 40 according to the first embodiment. Referring to FIG. 5, sensor devices 30 and 40 each include as main constituent elements, a CPU 202 for performing various types of processing, a memory 204 for storing motion information and a program executed by CPU 202, an acceleration sensor 206 capable of measuring an acceleration in directions of three axes, an angular speed sensor 208 capable of measuring an angular speed around each of the three axes, a communication interface (I/F) 210 for communicating with terminal device 10 and server 20, and a storage battery 212 supplying electric power to various components of sensor devices 30 and 40.

<Scheme for Calculating Evaluation Parameter>

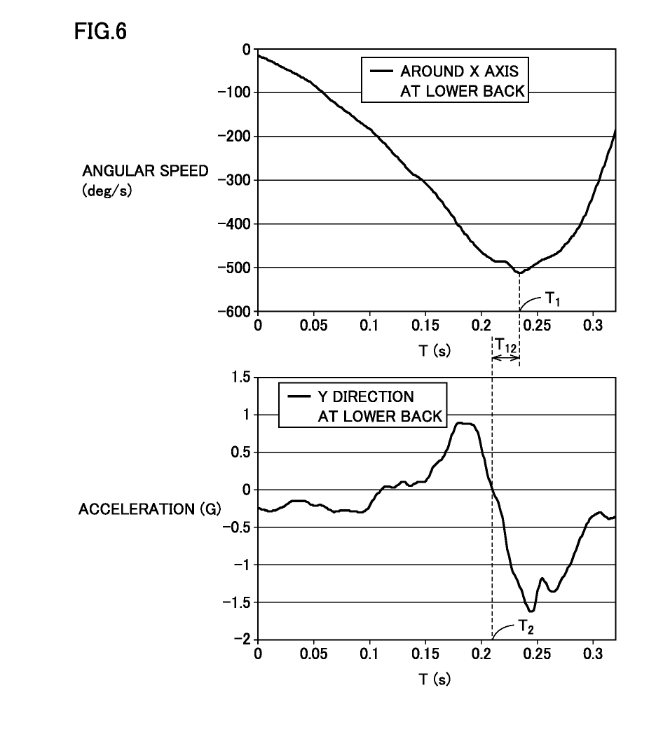

A scheme for calculating an evaluation parameter which has been found to be important in evaluation of a swing by a batter as a result of dedicated studies conducted by the present inventor will be described with reference to FIGS. 6 to 13.

(Evaluation Parameter A)

FIG. 6 is a diagram (No. 1) for illustrating a scheme for calculating an evaluation parameter calculated from motion information. A graph in an upper portion in FIG. 6 shows relation between a time T (s) and an angular speed (deg/s) around a body axis (the X axis) at the lower back portion. A graph in a lower portion in FIG. 6 shows relation between time T (s) and an acceleration (G) in a direction of swing (a Y direction) at the lower back portion. Original data for the graphs shown in FIG. 6 is obtained by sensor device 30 attached to the lower back portion of the batter who takes a swing.

Terminal device 10 finds as an evaluation parameter A, a time difference T₁₂ between a time T₁ at which an angular speed (a rotation speed) around the body axis at the lower back portion is maximal (a measurement value is maximal or minimal, that is, an absolute value is maximal) and a time T₂ at which an acceleration in a direction of swing at the lower back portion is zero (hereinafter also simply referred to as a “time difference T₁₂”).

Specifically, time T₂ is a time of a moment of switch of an acceleration in the direction of swing from positive to negative (in a case of a right-handed person, from negative to positive) (that is, an acceleration being zero) at the time when a batter steps at the time of the swing, makes translation motion in the direction of swing, and makes transition to rotational motion while stopping the translation motion. Therefore, a time at which an acceleration gradually decreases to zero after the acceleration increases from around T=0.15 and attains to the positive maximum around T=0.18 is defined as T₂.

In the example in FIG. 6, a condition of T₁=0.235 and T₂=0.208 is satisfied, and hence time difference T₁₂ is 0.027 (T₁₂=0.027). As time difference T₁₂ is smaller, a “wall” has well been made so that force from rotational motion of the lower back can lead well to acceleration of a swing of the bat, which can lead to estimation as a high swing level. The swing level is not dependent on relation in magnitude between T₁ and T₂, but dependent on time difference T₁₂ (an absolute value) between T₁ and T₂.

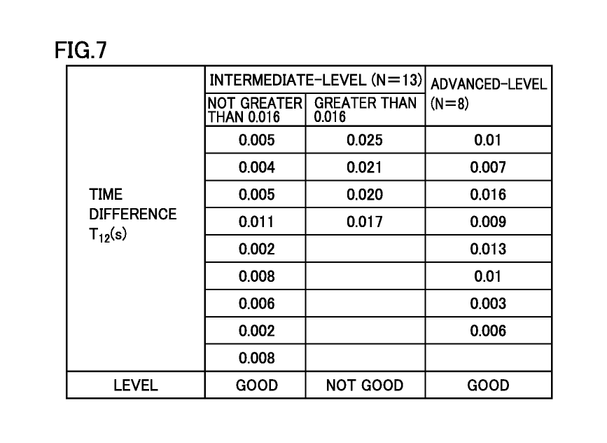

FIG. 7 is a diagram showing a result of calculation of evaluation parameter A (time difference T₁₂) for each of a plurality of intermediate-level persons and advanced-level persons. Here, a professional baseball player is selected as an “advanced-level person”. A person who belongs to a general high-school baseball club is selected as an “intermediate-level person”.

Referring to FIG. 7, maximal time difference T₁₂ of the advanced-level persons is 0.016, whereas maximal time difference T₁₂ of the intermediate-level persons is 0.025 greater than that of the advanced-level persons, which indicates that one is more advanced as time difference T₁₂ is smaller. It can be seen that there are as many as 4 intermediate-level persons who are greater in time difference than the advanced-level persons whose maximal time difference T₁₂ is 0.016.

For example, it is assumed that a rule is created for determining proficiency of intermediate-level persons in switch from translation motion of a lower body to rotational motion (a swing level) with maximal time difference T₁₂=0.016 of the advanced-level persons being defined as a boundary. Based on this rule, 9 of 13 intermediate-level persons are at a “good” level and 4 of them are at a “not good” level. Referring to FIG. 7, it can be seen that, even among the intermediate-level persons, there are some who are able to securely form the “wall” comparably to the advanced-level persons.

(Evaluation Parameter B)

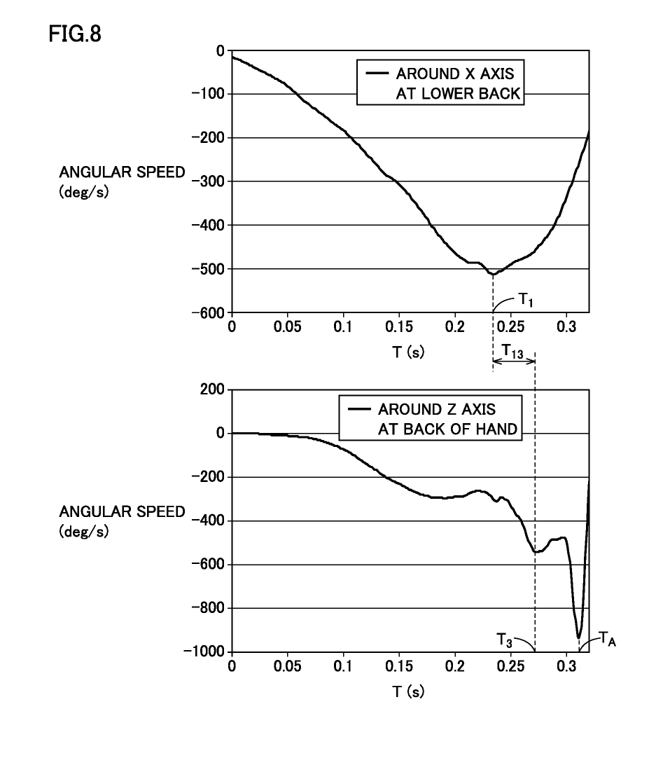

FIG. 8 is a diagram (No. 2) for illustrating a scheme for calculating an evaluation parameter calculated from motion information. A graph in an upper portion in FIG. 8 shows relation between time T (s) and an angular speed (deg/s) around the body axis (the X axis) at the lower back portion. A graph in a lower portion in FIG. 8 shows relation between time T (s) and an angular speed (deg/s) around the axis (the Z axis) extending in a direction orthogonal to the back of the hand. Original data for these graphs is obtained by sensor devices 30 and 40 attached to the batter who takes a swing.

Terminal device 10 finds as an evaluation parameter B, a time difference T₁₃ between time T₁ at which an absolute value of an angular speed (a rotation speed) around the body axis at the lower back portion is maximal and a time T₃ at which an absolute value of an angular speed around the axis orthogonal to the back of the hand (around the Z axis) is maximal immediately before impact (hereinafter also simply referred to as a “time difference T₁₃”). Immediately before impact means a period until a time before an impact time by a prescribed time period (for example, around 5/100 second).

When time T₃ is a time at which a value for an angular speed around the axis orthogonal to the back of the hand is maximal (an absolute value is maximal) until an impact time T_{A}, time T₃ is at 0.271 (T₃=0.271).

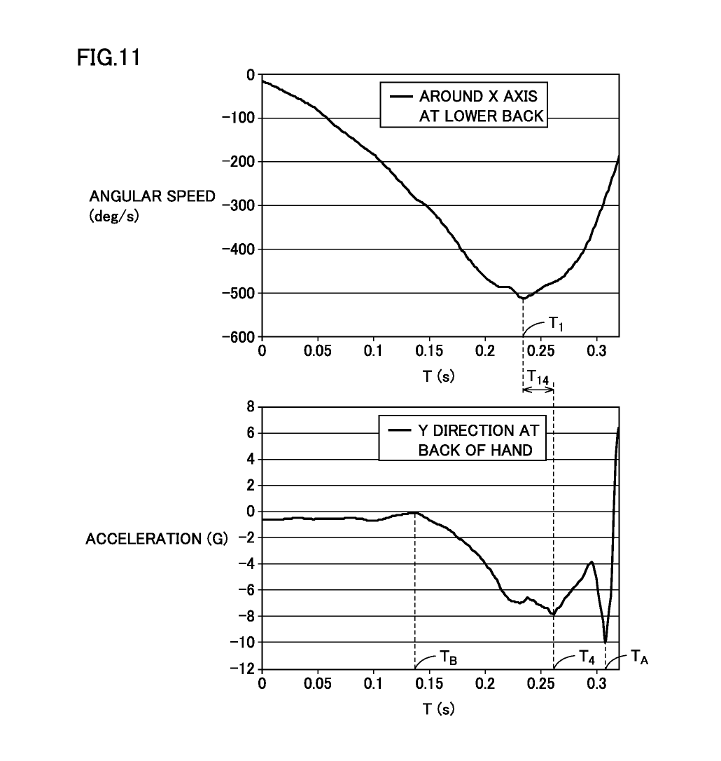

Here, impact time T_{A} will be described. At the time of impact, a signal from acceleration sensor 206 of sensor device 40 attached to the back of the hand provides transient response to the impact of hitting of a ball and hence an acceleration abruptly changes. Therefore, for example, a time at which an absolute value of an acceleration around the axis orthogonal to the back of the hand is maximal after transient response is defined as “impact time T_{A}” (see a graph in a lower portion in FIG. 11 which will be described later). In the present embodiment, impact time T_{A} is at 0.307.

In the example in FIG. 8, a condition of T₁=0.235 and T₃=0.271 is satisfied, and hence time difference T₁₃ is 0.036 (T₁₃=0.036). Greater time difference T₁₃ indicates that a hand (an arm) follows motion of the lower back and hence a bat can be swung like a whip in a hitting zone. Therefore, a head speed of the bat increases. Namely, greater time difference T₁₃ indicates better use of a lower body, which can lead to estimation as a high swing level.

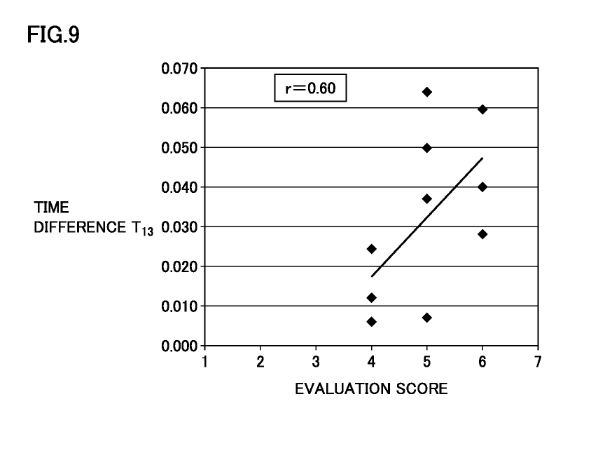

FIG. 9 is a diagram showing correlation between evaluation parameters B (time difference T₁₃) of a plurality of baseball club members and sensory evaluation by a skilled instructor of a swing by those intermediate-level persons. Time difference T₁₃ shown in FIG. 9 represents an average value of three attempts made by each batter. The skilled instructor refers, for example, to a manager of a baseball club and an experienced person who can appropriately determine a swing level of a batter. Sensory evaluation was conducted by the skilled instructor by giving scores of 1, 2, 3, . . . on a scale from 1 to 7 for each baseball club member. Here, 7 is the highest score in evaluation and 1 is the lowest score in evaluation. The scores from 7 to 1 are spaced uniformly.

Referring to FIG. 9, a coefficient of correlation R is 0.60, and it can be seen that time difference T₁₃ and a score in sensory evaluation by the skilled instructor exhibit relatively high correlation, which means that objective evaluation of a swing by a batter can be made by finding time difference T₁₃ even though evaluation is not made by a skilled instructor.

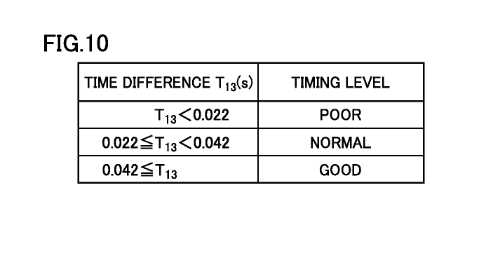

FIG. 10 is a diagram exemplifying relation between evaluation parameter B and a swing level. FIG. 10 shows a swing level in three stages in accordance with a value for time difference T₁₃. Specifically, such a rule has been created that determination as a “poor” level is made when a condition of T₁₃<0.022 is satisfied, determination as a “normal” level is made when a condition of 0.022≦T₁₃<0.042 is satisfied, and determination as a “good” level is made when a condition of 0.042≦T₁₃ is satisfied.

Here, a hand (an arm) precedes the lower back with a batter who is negative in time difference T₁₃, which means that he/she is completely unable to swing a bat like a whip in a hitting zone.

(Evaluation Parameter C)

FIG. 11 is a diagram (No. 3) for illustrating a scheme for calculating an evaluation parameter calculated from motion information. A graph in an upper portion in FIG. 11 shows relation between time T (s) and an angular speed (deg/s) around the body axis (the X axis) at the lower back portion. A graph in a lower portion in FIG. 11 shows relation between time T (s) and an acceleration (G) in a direction of swing (the Y direction) at the back of the hand. Original data for these graphs is obtained by sensor devices 30 and 40 attached to the batter who takes a swing.

Terminal device 10 finds as an evaluation parameter C, a time difference T₁₄ between time T₁ at which an absolute value of an angular speed (a rotation speed) around the body axis (the X axis) at the lower back portion is maximal and a time T₄ at which a rate of change in acceleration in a direction of swing (the Y direction) at the back of the hand is zero (hereinafter also simply referred to as a “time difference T₁₄”).

Specifically, time T₄ is a time at which a rate of change in acceleration in the direction of swing at the back of the hand is zero and the acceleration is maximal (an absolute value is maximal) at a time point closest to impact time T_{A}.

In the example in FIG. 11, a condition of T₁=0.235 and T₄=0.261 is satisfied, and hence time difference T₁₄ is 0.026 (T₁₄=0.026). Similarly to time difference T₁₃, time difference T₁₄ is an evaluation parameter for objectively evaluating superiority in use of a lower body. Specifically, greater time difference T₁₄ indicates that a hand (an arm) follows motion of the lower back and hence a bat can be swung like a whip in a hitting zone. Therefore, a head speed of the bat increases. Namely, greater time difference T₁₄ indicates better use of a lower body, which can lead to estimation as a high swing level.

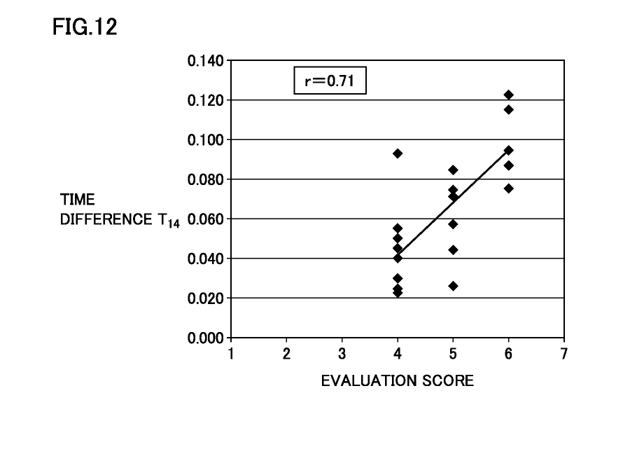

FIG. 12 is a diagram showing correlation between evaluation parameters C (time difference T₁₄) of a plurality of baseball club members and sensory evaluation by a skilled instructor of swing by each baseball club member. Time difference T₁₄ shown in FIG. 12 represents an average value of three attempts made by each batter. Similarly to FIG. 9, the skilled instructor is a manager of a baseball club, and sensory evaluation was conducted by the skilled instructor by giving scores of 1, 2, 3, . . . on a scale from 1 to 7 for each baseball club member. Here, 7 is the highest score in evaluation and 1 is the lowest score in evaluation. The scores from 7 to 1 are spaced uniformly. Referring to FIG. 12, coefficient of correlation R is 0.71, and it can be seen that time difference T₁₄ and a score in sensory evaluation by the skilled instructor exhibit relatively high correlation, which means that objective evaluation of a swing by a batter can be made also by finding time difference T₁₄, even though evaluation is not made by a skilled instructor.

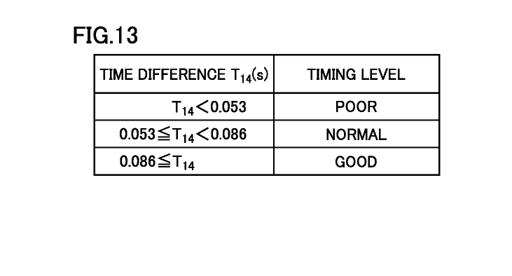

FIG. 13 is a diagram exemplifying relation between evaluation parameter C and a swing level. FIG. 13 shows a swing level in three stages in accordance with a value for time difference T₁₄. Specifically, such a rule has been created that determination as a “poor” level is made when a condition of T₁₄<0.053 is satisfied, determination as a “normal” level is made when a condition of 0.053≦T₁₄<0.086 is satisfied, and determination as a “good” level is made when a condition of 0.086≦T₁₄ is satisfied. Here, a hand (an arm) precedes the lower back with a batter who is negative in time difference T₁₄, which means that he/she is completely unable to swing a bat like a whip in a hitting zone.

(Other Evaluation Parameters)

A “swing time period” and a “swing speed” are possible as other evaluation parameters in evaluation of a swing. The swing time period means a time difference between a swing start time and an impact time. The swing start time refers to a time at which a rate of change in acceleration in the direction of swing at the back of the hand is not smaller than a prescribed threshold value.

Referring to the graph in the lower portion in FIG. 11, a swing start time T_{B} is at 0.135 which is a time at which an acceleration significantly changes from a steady state. Therefore, a swing time period T_{AB} is 0.172 which is a time difference between impact time T_{A}=0.307 and swing start time T_{AB}=0.135.

A swing speed is found by multiplying a square-root of sum of squares of angular speeds around the three axes orthogonal to one another, which were measured by angular speed sensor 208 at the time of impact, by a length of a bat.

<Processing Procedure>

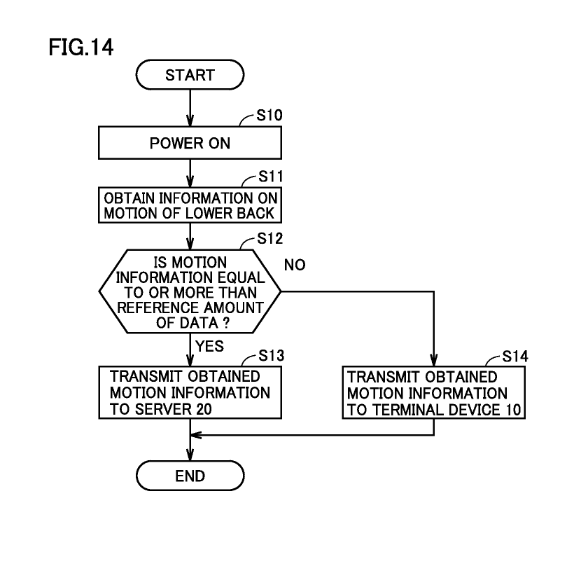

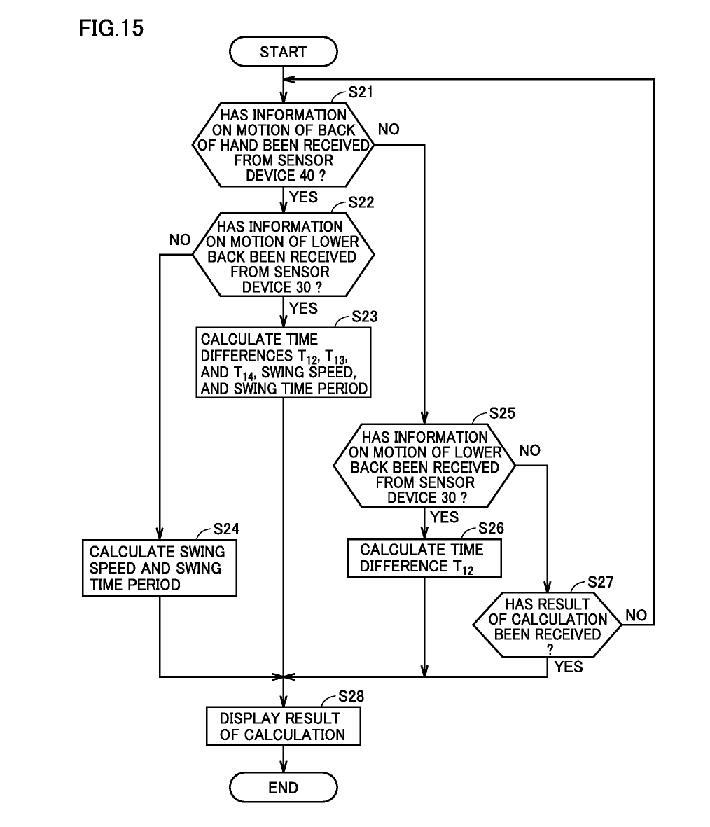

A detailed procedure of processing in sensor devices 30 and 40 and terminal device 10 included in measurement system 1 will now be described with reference to FIGS. 14 and 15.

(Sensor Devices 30 and 40)

Since a procedure of processing is basically the same in sensor device 30 and sensor device 40, a procedure of processing in sensor device 30 will mainly be described here.

FIG. 14 is a flowchart showing a procedure of processing in sensor device 30 according to the first embodiment. Each step below is implemented as CPU 202 executes a program stored in memory 204.

Initially, sensor device 30 is attached to a lower back portion of a batter and a power switch of sensor device 30 is turned ON (step S10).

Then, when the batter to which sensor device 30 is attached takes a swing, CPU 202 obtains an acceleration in each of directions of the three axes and an angular speed around each of the three axes as motion information on motion of the lower back portion during swing by the batter (hereinafter also referred to as “lower-back-portion information”) (step S11). Specifically, CPU 202 accepts input of a signal corresponding to an acceleration from acceleration sensor 206 and a signal corresponding to an angular speed from angular speed sensor 208. CPU 202 obtains lower-back-portion information by calculating the acceleration and the angular speed based on input signals.

CPU 202 determines whether or not obtained lower-back-portion information has an amount equal to or greater than a prescribed reference amount of data (step S12). For example, the prescribed reference amount of data refers to a total value for an amount of data on acceleration and an amount of data on an angular speed for 10 swings.

When the lower-back-portion information has an amount equal to or greater than the prescribed reference amount of data (YES in step S12), CPU 202 transmits the obtained lower-back-portion information to server 20 through communication interface 210 (step S13) and the process ends.

In contrast, when the lower-back-portion information does not have an amount equal to or greater than the prescribed data amount (NO in step S12), CPU 202 transmits the obtained lower-back-portion information to terminal device 10 through communication interface 210 (step S14) and the process ends.

In the procedure of processing performed in sensor device 40, in step S10, sensor device 40 is attached to the back of a hand of a batter and a power switch of sensor device 40 is turned ON, and in step S11, CPU 202 obtains back-of-hand information on motion of the back of the hand during swing by the batter. Subsequent processing corresponds to processing with the “lower-back-portion information” being replaced with the “back-of-hand information” in step S12 to step S14.

(Terminal Device 10)

FIG. 15 is a flowchart showing a procedure of processing in terminal device 10 according to the first embodiment. Each step below is implemented as CPU 102 executes a program stored in memory 104. Memory 104 stores in advance data on a length of a bat used by a batter (a subject) (for example, a length from a grip end to a sweet spot).

Referring to FIG. 15, CPU 102 of terminal device 10 determines whether or not motion information associated with the back of the hand (hereinafter also referred to as the “back-of-hand information”) has been received from sensor device 40 through communication interface 120 (step S21). When the back-of-hand information has been received (YES in step S21), CPU 102 determines whether or not lower-back-portion information has been received from sensor device 30 (step S22).

When the lower-back-portion information has been received (that is, the back-of-hand information and the lower-back-portion information have been received) (YES in step S22), CPU 102 calculates as evaluation parameters, time differences T₁₂, T₁₃, and T₁₄, a swing speed, and a swing time period based on the received back-of-hand information and lower-back-portion information (step S23), and performs processing in step S28 which will be described later.

Here, processing in step S23 will specifically be described. CPU 102 calculates time difference T₁₂ between time T₁ at which an absolute value of an angular speed around the body axis is maximal and time T₂ at which an acceleration in the direction of swing is zero, based on the angular speed around the body axis and the acceleration in the direction of swing at the lower back portion included in the received lower-back-portion information.

In addition, CPU 102 calculates time difference T₁₃ between time T₁ at which an absolute value of an angular speed around the body axis is maximal and time T₃ at which an absolute value of an angular speed around the axis orthogonal to the back of the hand is maximal immediately before impact, based on the angular speed around the body axis included in the received lower-back-portion information and the angular speed around the axis orthogonal to the back of the hand included in the received back-of-hand information.

Furthermore, CPU 102 calculates time difference T₁₄ between time T₁ at which an absolute value of an angular speed around the body axis is maximal and time T₄ at which a rate of change in acceleration in the direction of swing at the back of the hand is zero, based on the angular speed around the body axis included in the received lower-back-portion information and the acceleration in the direction of swing at the back of the hand included in the received back-of-hand information.

Moreover, CPU 102 calculates a swing speed at the time of impact based on the angular speed around each of the three axes at the back of the hand included in the received back-of-hand information and a length of the bat stored in memory 104. CPU 102 finds a swing time period of the subject based on the acceleration in the direction of swing at the back of the hand included in the received back-of-hand information.

When the lower-back-portion information has not been received in step S22 (that is, only the back-of-hand information has been received) (NO in step S22), CPU 102 calculates a swing speed and a swing time period as evaluation parameters based on the received back-of-hand information (step S24), and performs processing in step S28 which will be described later.

When the back-of-hand information has not been received in step S21 (NO in step S21), CPU 102 determines whether or not lower-back-portion information has been received (step S25). When the lower-back-portion information has been received (that is, only the lower-back-portion information has been received) (YES in step S25), CPU 102 calculates time difference T₁₂ (step S26) and performs processing in step S28 which will be described later.

In contrast, when the lower-back-portion information has not been received (that is, neither of the back-of-hand information and the lower-back-portion information has been received), CPU 102 determines whether or not a result of calculation of an evaluation parameter has been received from server 20 (step S27). When the result of calculation has been received (YES in step S27), CPU 102 performs processing in step S28 which will be described later.

Then, CPU 102 outputs the calculated result (step S28). Specifically, when CPU 102 has calculated time differences T₁₂, T₁₃, and T₁₄, a swing speed, and a swing time period in step S23, CPU 102 has these evaluation parameters displayed on display 110. When CPU 102 has calculated a swing speed and a swing time period in step S24, CPU 102 has these evaluation parameters displayed on display 110. When CPU 102 has calculated time difference T₁₂ in step S26, CPU 102 has this evaluation parameter displayed on display 110. When CPU 102 has received the result of calculation of the evaluation parameter in step S27, CPU 102 has the evaluation parameter in accordance with the received result of calculation displayed on display 110.

CPU 102 may evaluate a swing level of a subject based on the calculated result, and has the result of evaluation displayed on display 110. Specifically, CPU 102 evaluates whether the swing level of the subject is “good” or “not good” based on calculated time difference T₁₂ and the rule described with reference to FIG. 7, and has the result of evaluation displayed on display 110.

CPU 102 evaluates the swing level of the subject as “poor”, “normal”, or “good” based on calculated time difference T₁₃ and the rule shown in FIG. 10, and has the result of evaluation displayed on display 110. Furthermore, CPU 102 evaluates the swing level of the subject as “poor”, “normal”, or “good” based on calculated time difference T₁₄ and the rule shown in FIG. 13, and has the result of evaluation displayed on display 110.

CPU 102 may have each result of evaluation displayed separately or has one result of evaluation displayed, with results of evaluation being integrated. Namely, a manner of display which allows a subject to be notified of his/her own swing level should only be provided.

### Second Embodiment

A case that terminal device 10 calculates an evaluation parameter based on motion information received from sensor devices 30 and 40 and outputs the result of calculation has been described in connection with measurement system 1 according to the first embodiment. In a second embodiment, a configuration in which a terminal device has a sensor function of a sensor device and functions as a measurement device for measuring motion during swing by a subject will be described. A difference from the first embodiment is described in the second embodiment, and detailed description of the same features and functions will not be repeated.

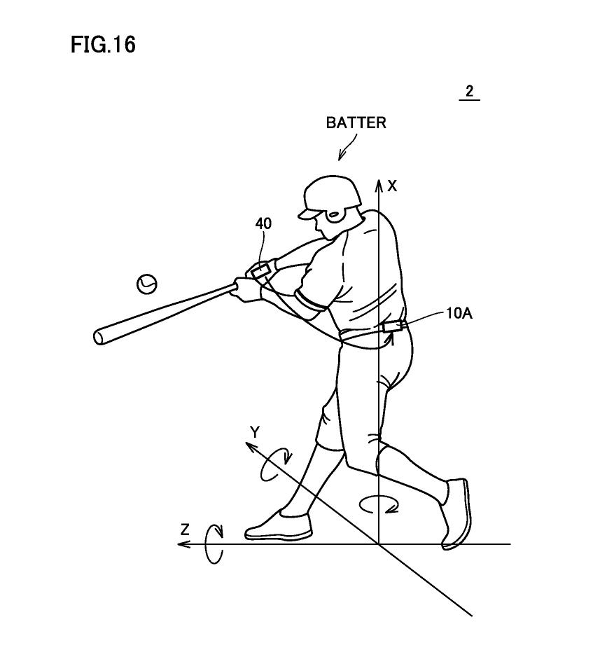

FIG. 16 is a diagram showing an overall configuration of a measurement system 2 according to the second embodiment. Measurement system 2 includes a terminal device 10A attached to a lower back portion of a batter and sensor device 40 attached to a back of a hand of the batter.

Terminal device 10A is attached to the lower back portion of the batter with a lower-back-portion attachment member being interposed, instead of sensor device 30 in the first embodiment. Therefore, terminal device 10A is preferably portable, as exemplified by a smartphone or a tablet terminal. Namely, terminal device 10A functions as a measurement device attached to a lower back portion of a batter, for measuring motion of the batter.

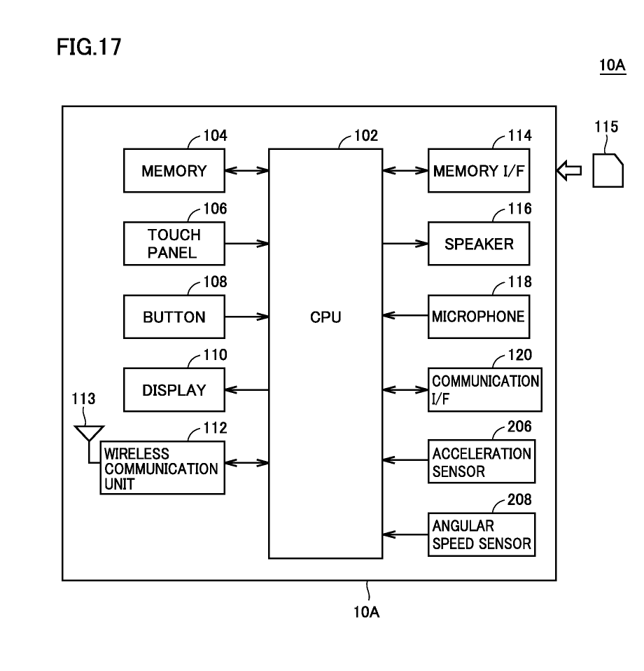

FIG. 17 is a diagram showing a hardware configuration of terminal device 10A according to the second embodiment. Terminal device 10A includes as main constituent elements, CPU 102, memory 104, touch panel 106, button 108, display 110, wireless communication unit 112, communication antenna 113, memory interface (I/F) 114, speaker 116, communication interface (I/F) 120, microphone 118, acceleration sensor 206, and angular speed sensor 208.

Acceleration sensor 206 and angular speed sensor 208 function as a detection unit capable of obtaining motion information on motion of the lower back portion during swing of the subject. Since other features of terminal device 10A are the same as those of terminal device 10 shown in FIG. 4, detailed description thereof will not be repeated.

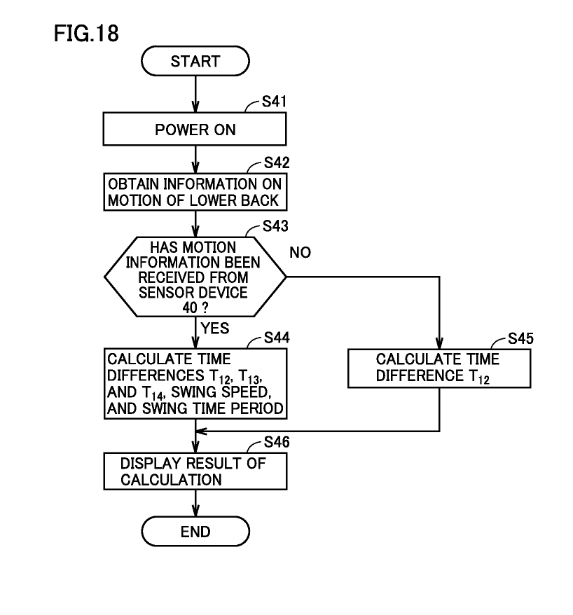

FIG. 18 is a flowchart showing a procedure of processing in terminal device 10A according to the second embodiment. Each step below is implemented as CPU 102 executes a program stored in memory 104.

Initially, terminal device 10A is attached to a lower back portion of a batter and a power switch of terminal device 10A is turned ON (step S41).

Then, when the batter to which terminal device 10A is attached takes a swing, CPU 102 obtains from acceleration sensor 206 and angular speed sensor 208 an acceleration in each of directions of the three axes and an angular speed around each of the three axes as motion information on motion of the lower back portion during swing by the batter (step S42).

Then, CPU 102 determines whether or not back-of-hand information obtained by sensor device 40 attached to the back of the hand of the batter has been received through communication interface 120 (step S43). When back-of-hand information has been received (YES in step S43), CPU 102 calculates time differences T₁₂, T₁₃, and T₁₄, a swing speed, and a swing time period, based on the lower-back-portion information obtained through acceleration sensor 206 and angular speed sensor 208 and the back-of-hand information received from sensor device 40 (step S44). Then, CPU 102 has the result of calculation displayed (step S46) and the process ends.

In contrast, when the back-of-hand information has not been received (NO in step S43), CPU 102 calculates time difference T₁₂ based on the lower-back-portion information (step S45) and has the result of calculation displayed (step S46). Then, CPU 102 has the process end.

Though a case that terminal device 10A is attached to a lower back portion of a batter has been described in the second embodiment, it may be attached to a back of a hand instead of sensor device 40 in the first embodiment. In this case, sensor device 30 is attached to the lower back portion of the batter. Then, terminal device 10A calculates at least one evaluation parameter based on the obtained back-of-hand information and the lower-back-portion information received from sensor device 30.

Though a configuration including no server 20 has been described in the second embodiment, server 20 may be included. In this case, as described in the first embodiment, terminal device 10A and sensor device 40 may be configured to transmit motion information to server 20 when an amount of data of obtained motion information is not smaller than a prescribed reference amount of data.

### Other Embodiments

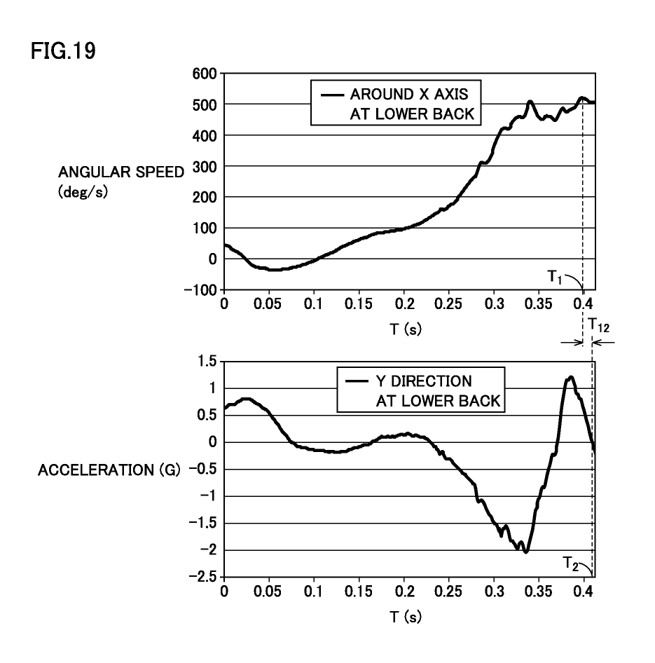

Though a case that a subject is a batter has been described in the embodiments described above, limitation thereto is not intended and the subject may be, for example, a tennis player. Here, ability to calculate an evaluation parameter as described above with a calculation scheme the same as in the case of a batter in spite of a subject being a tennis player will be described with reference to FIGS. 19 to 23. Here, the subject is a right-handed tennis player. It is assumed that a sensor device is attached to each of a lower back portion and a back of a hand of the subject and the subject takes a forehand swing.

FIG. 19 is a diagram (No. 4) for illustrating a scheme for calculating an evaluation parameter calculated from motion information. A graph in an upper portion in FIG. 19 shows relation between time T (s) and an angular speed (deg/s) around the body axis (the X axis) at the lower back portion. A graph in a lower portion in FIG. 19 shows relation between time T (s) and an acceleration (G) in a direction of swing (the Y direction) at the lower back portion.

Referring to FIG. 19, as evaluation parameter A, time difference T₁₂ between time T₁ at which an absolute value of an angular speed around the body axis at the lower back portion is maximal and time T₂ at which an acceleration in a direction of swing at the lower back portion is zero is found.

Specifically, time T₂ is a time of a moment of switch of an acceleration in the direction of swing from positive to negative (in a case of a left-handed person, from negative to positive) (that is, an acceleration is zero) at the time when a tennis player steps at the time of the swing, makes translation motion in the direction of swing, and makes transition to rotational motion while stopping the translation motion. Therefore, a time at which an acceleration gradually decreases to zero after the acceleration attains to the positive maximum around T=0.37 is defined as T₂.

In the example in FIG. 19, a condition of T₁=0.398 and T₂=0.408 is satisfied, and hence time difference T₁₂ is 0.010 (T₁₂=0.010). In the case of tennis as well, as time difference T₁₂ is smaller, a “wall” can well be made so that force from rotational motion of the lower back can lead well to acceleration of a swing of a racket, which can be evaluated as a high swing level.

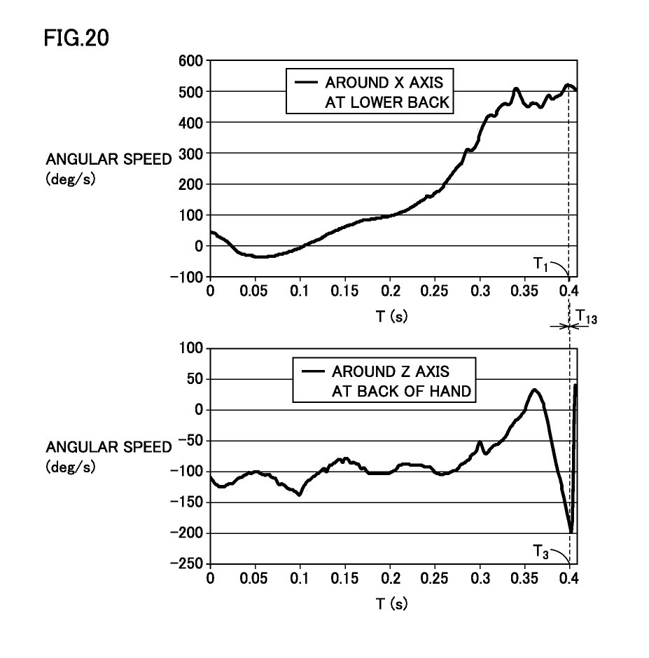

FIG. 20 is a diagram (No. 5) for illustrating a scheme for calculating an evaluation parameter calculated from motion information. A graph in an upper portion in FIG. 20 shows relation between time T (s) and an angular speed (deg/s) around the body axis (the X axis) at the lower back portion. A graph in a lower portion in FIG. 20 shows relation between time T (s) and an angular speed (deg/s) around an axis extending in a direction orthogonal to a back of a hand (the Z axis).

Referring to FIG. 20, as evaluation parameter B, time difference T₁₃ between time T₁ at which an absolute value of an angular speed (a rotation speed) around the body axis (the X axis) at the lower back portion is maximal and time T₃ at which an angular speed around the axis orthogonal to the back of the hand (around the Z axis) is maximal (that is, an absolute value of a measurement value is maximal) is found.

In the example in FIG. 20, a condition of T₁=0.398 and T₃=0.400 is satisfied, and hence time difference T₁₃ is 0.002 (T₁₃=0.002). In the case of tennis as well, greater time difference T₁₃ indicates that a hand (an arm) follows motion of the lower back and hence a racket can be swung like a whip in a hitting zone. Therefore, a head speed of the racket increases. Namely, in the case of tennis as well, greater time difference T₁₃ indicates better use of a lower body, which can be evaluated as a high swing level.

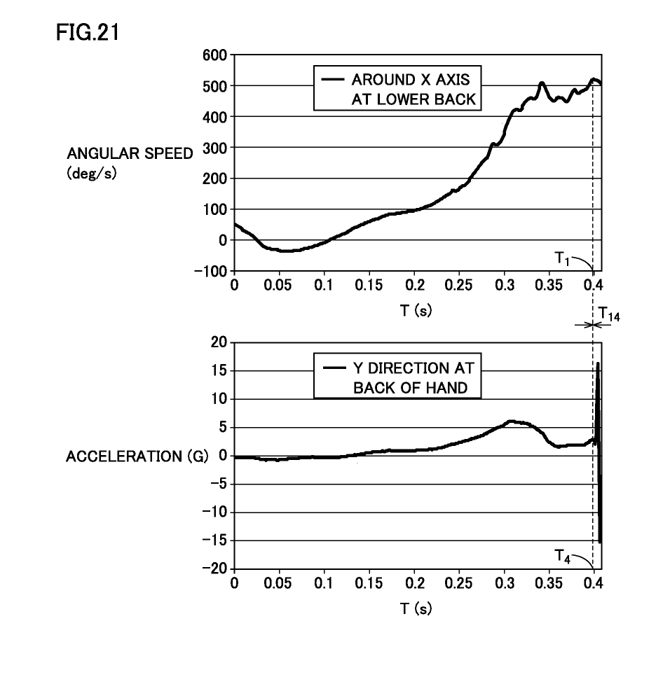

FIG. 21 is a diagram (No. 6) for illustrating a scheme for calculating an evaluation parameter calculated from motion information. A graph in an upper portion in FIG. 21 shows relation between time T (s) and an angular speed (deg/s) around the body axis (the X axis) at the lower back portion. A graph in a lower portion in FIG. 21 shows relation between time T (s) and an acceleration (G) in a direction of swing (the Y direction) at the back of the hand.

Referring to FIG. 21, as evaluation parameter C, time difference T₁₄ between time T₁ at which an absolute value of an angular speed (a rotation speed) around the body axis (the X axis) at the lower back portion is maximal and time T₄ at which a rate of change in acceleration in the direction of swing (the Y direction) at the back of the hand is zero is found.

Specifically, time T₄ is a time at which change in acceleration in the direction of swing at the back of the hand is zero and the acceleration is maximal (an absolute value is maximal) at a time point closest to impact time T_{A}=0.401.

In the example in FIG. 21, a condition of T₁=0.398 and T₄=0.398 is satisfied, and hence time difference T₁₄ is 0 (T₁₄=0). Similarly to time difference T₁₃, time difference T₁₄ is an evaluation parameter for objectively evaluating superiority in use of a lower body. Specifically, in the case of tennis as well, greater time difference T₁₄ indicates better use of a lower body, which can be evaluated as a high swing level.

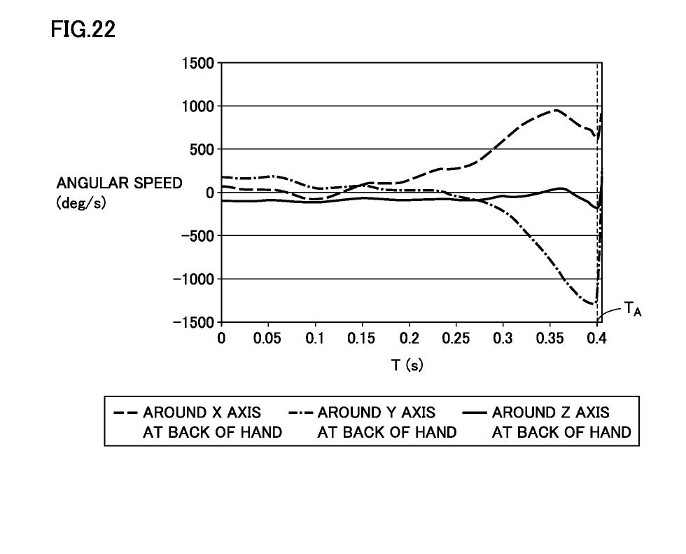

FIG. 22 is a diagram (No. 7) for illustrating a scheme for calculating an evaluation parameter calculated from motion information. A graph in FIG. 22 shows relation between time T (s) and an angular speed (deg/s) around each of the three axes at the back of the hand.

At impact time T_{A}=0.401, an angular speed around the X axis wx=659.7, an angular speed around the Y axis wy=−1176.9, and an angular speed around the Z axis wz=−198.2. Therefore, a square-root of sum of squares of the angular speeds around the three axes at the time of impact is calculated as 1363.7. Therefore, a swing speed is found by multiplying the square-root of sum of squares by a length of a racket (for example, a length from a grip end to a sweet spot).

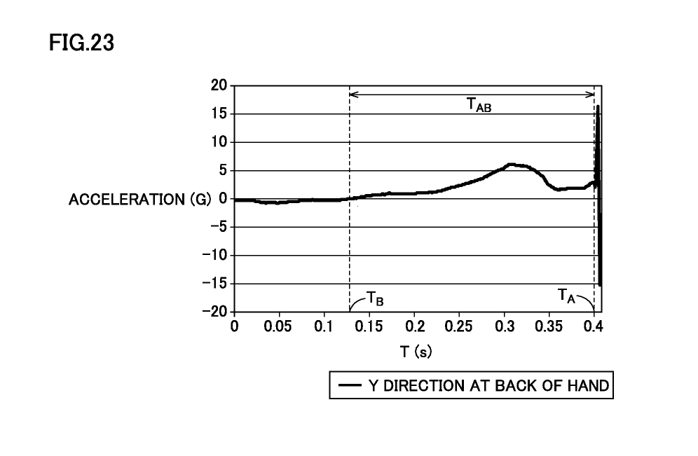

FIG. 23 is a diagram (No. 8) for illustrating a scheme for calculating an evaluation parameter calculated from motion information. A graph in FIG. 23 shows relation between time T (s) and an acceleration (G) in the direction of swing (the Y direction) at the back of the hand.

Swing start time T_{B} is at 0.129 which is a time at which an acceleration significantly changes from a steady state. Therefore, swing time period T_{AB} is found as 0.272 which is a time difference between impact time T_{A}=0.401 and swing start time T_{B}=0.129.

As above, when a tennis racket is swung, as in bat swing, correlation between a score given by an expert and an evaluation parameter is found in advance and held as data, so that swing by a subject can be evaluated.

### Modifications and Features

Modifications and features in the present embodiment described above will now be listed.

In the present embodiment described above, though a configuration in which a device having a sensor function is attached to each of a lower back portion and a back of a hand of a subject has been described, limitation thereto is not intended. For example, terminal device 10A may be attached only to a lower back portion of a subject, evaluation parameter A (time difference T₁₂) may be calculated, and a result of calculation may be output.

Though a case that a subject uses a ball hitting instrument to take a swing at a ball has been described in the present embodiment, limitation thereto is not intended and the subject may take a practice swing.

Though a case that an evaluation parameter or a swing level is displayed on a display has been described in the present embodiment, limitation thereto is not intended. For example, a subject may be notified of an evaluation parameter or a swing level with audio sound through a speaker.

Though a case that a terminal device receives motion information transmitted from a sensor device and calculates an evaluation parameter based on the motion information has been described in the present embodiment, limitation thereto is not intended. For example, a terminal device may be configured to accept input of motion information obtained by a sensor device from a user through a touch panel or a button.

Though a case that a subject is a batter or a tennis player and motion during swing of a bat and a tennis racket is measured has been described in the present embodiment, limitation thereto is not intended. Motion during swing by a subject can be measured and a swing can be evaluated in sports mainly making use of rotation of a lower back to thereby take a lateral swing (for example, table tennis) like the sports above.

A program for carrying out control as described in the flowcharts described above by functioning a computer can also be provided. Such a program can also be recorded in a non-transitory computer-readable recording medium such as a flexible disc, a CD-ROM (Compact Disk Read Only Memory), a ROM, a RAM, and a memory card, to be attached to a computer, and can also be provided as a program product. Alternatively, a program can also be provided as recorded in a recording medium such as a hard disk contained in a computer. Alternatively, a program can also be provided by downloading through a network.

A program may invoke a necessary module from among program modules provided as a part of an operation system (OS) of the computer at prescribed timing and cause the module to perform processing. Here, the program itself does not include the module above but processing is performed in cooperation with the OS. Such a program not including a module may also be encompassed in the program according to the present embodiment.

In addition, the program according to the present embodiment may be provided as incorporated as a part of another program. In this case as well, the program itself does not include the module included in another program above but processing is performed in cooperation with another program. Such a program incorporated in another program may also be encompassed in the program according to the present embodiment.

### Effects of Embodiment

According to the present embodiment, characteristics of each motion associated with a lower back and a back of a hand (an arm) which is important during swing can objectively be known. By determining prescribed timing in motion of the lower back and the back of the hand, superiority in use of an upper body and a lower body can also be evaluated.

Characteristics of motion during swing can objectively be presented to a subject. Therefore, superiority in swing which has been difficult to determine unless one who makes determination is a skilled instructor can objectively be indicated.

Furthermore, motion in swing at the time when a subject actually hits a ball can be measured. Motion in swing with a ball hitting instrument, which is owned by a subject himself/herself and to which he/she is used, can be measured without requiring a ball hitting instrument such as a dedicated bat or racket. Therefore, the subject can know characteristics of motion during swing and a swing level which are close to those in an actual game.

Moreover, since it is only necessary to attach a small device to a lower back portion and a back of a hand of a subject and to take a swing, measurement can be simple without burden being imposed on the subject. The subject can obtain a result of evaluation of a swing in real time.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A measurement system for measuring motion of a subject, comprising:
a detection unit attached to a lower back portion of the subject and configured to obtain motion information on motion of the lower back portion during swing by the subject;
a processing unit configured to find an evaluation parameter for a swing by the subject based on the motion information obtained by the detection unit; and
an output unit configured to output the evaluation parameter found by the processing unit.

2. The measurement system according to claim 1, wherein
the motion information includes an angular speed around a body axis of the subject and an acceleration in a direction of swing at the lower back portion of the subject, and
the processing unit calculates as the evaluation parameter, a time difference between a time at which an absolute value of the angular speed around the body axis is maximal and a time at which the acceleration in the direction of swing is zero.

3. A measurement system for measuring motion of a subject, comprising:
a first detection unit attached to a lower back portion of the subject and configured to obtain first motion information on motion of the lower back portion during swing by the subject;
a second detection unit attached to a back of a hand of the subject and configured to obtain second motion information on motion of the back of the hand during swing by the subject;
a processing unit configured to find at least one evaluation parameter for a swing by the subject based on the first motion information obtained by the first detection unit and the second motion information obtained by the second detection unit; and
an output unit configured to output the at least one evaluation parameter found by the processing unit.

4. The measurement system according to claim 3, wherein
the first motion information includes an angular speed around a body axis of the subject,
the second motion information includes an angular speed around an axis orthogonal to the back of the hand of the subject, and
the processing unit finds a time difference between a time at which an absolute value of the angular speed around the body axis of the subject is maximal and a time at which an absolute value of the angular speed around the axis orthogonal to the back of the hand of the subject is maximal immediately before impact.

5. The measurement system according to claim 3, wherein
the second motion information further includes an acceleration in a direction of swing at the back of the hand of the subject, and
the processing unit finds a time difference between a time at which an absolute value of an angular speed around a body axis of the subject is maximal and a time at which a rate of change in acceleration in the direction of swing at the back of the hand of the subject is zero.

6. The measurement system according to claim 3, wherein
the second motion information further includes respective angular speeds around three axes at the back of the hand of the subject, and
the processing unit finds a swing speed at impact based on a square-root of sum of squares of the angular speeds around the three axes at the impact and a total length of a bat used by the subject.

7. The measurement system according to claim 3, wherein
the second motion information further includes an acceleration in a direction of swing at the back of the hand of the subject, and
the processing unit calculates a swing time period of the subject by finding a time difference between a time at which a rate of change in acceleration in the direction of swing at the back of the hand of the subject is not smaller than a predetermined threshold value and an impact time.

8. The measurement system according to claim 1, wherein
the processing unit evaluates a swing level of the subject based on the evaluation parameter obtained from the subject and a predetermined rule, and
the output unit outputs the swing level together with the evaluation parameter.

9. A measurement device attached to a lower back portion of a subject for measuring motion of the subject, comprising:
a first detection unit configured to obtain first motion information on motion of the lower back portion during swing by the subject;
an input unit configured to accept input of second motion information on motion of a back of a hand during swing by the subject, which is obtained by a second detection unit attached to the back of the hand of the subject;
a processing unit configured to find at least one evaluation parameter for a swing by the subject based on the first motion information obtained by the first detection unit and the second motion information of which input has been accepted by the input unit; and
an output unit configured to output the at least one evaluation parameter found by the processing unit.
